(19) United States
(12) Patent Application Publication
(10) Pub. No.: US 2009/0157435 A1
(43) Pub. Date: Jun. 18, 2009

(54) SYSTEM AND METHOD OF ACCELERATED HEALTH CARE CLAIM PAYMENT

(75) Inventor: Christopher David Seib, Costa Mesa, CA (US)

Correspondence Address: PEPPER HAMILTON LLP, ONE MELLON CENTER, 50TH FLOOR, 500 GRANT STREET, PITTSBURGH, PA, 15219, US

(73) Assignee: INSTAMED COMMUNICATIONS, LLC, Philadelphia, PA (US)

(21) Appl. No.: 12/332,958

(22) Filed: Dec. 11, 2008

Related U.S. Application Data
(60) Provisional application No. 61/013,763, filed on Dec. 14, 2007.

(51) Int. Cl. G06Q 40/00; G06Q 50/00

(52) U.S. Cl. 705/4; 705/2

(57) ABSTRACT

A method of accelerating a health care claim payment may include filtering a claim to determine whether the claim is eligible for accelerated claim payment. A payment amount for a claim may be determined by a computing device by retaining a provider level adjustment. The payment amount may be automatically paid via electronic funds transfer. A portion of the provider level adjustment may be distributed via electronic funds transfer.

### CLAIM OF PRIORITY AND RELATED APPLICATION

This patent application claims priority to U.S. Provisional Patent No. 61/013,763, entitled “Accelerated Health Care Claim Payment System,” filed on Dec. 14, 2007, which is hereby incorporated by reference in its entirety.

### SUMMARY

In an embodiment, a method of accelerating a health care claim payment may include filtering a claim to determine whether the claim is eligible for accelerated claim payment. A payment amount for the claim may be determined, via a computing device by retaining a provider level adjustment. The payment amount may be automatically paid via electronic funds transfer. A portion of the provider level adjustment may be distributed via electronic funds transfer.

In an embodiment, distributing a portion of the provider level adjustment may include distributing a portion of the provider level adjustment only if a service level is exceeded. Filtering the claim to determine whether the claim is eligible for accelerated claim payment may include obtaining a plurality of provider's parameters, determining if data from the claim corresponds with the provider's parameters, obtaining a plurality of payer's parameters, determining if data from the claim corresponds with the payer's parameters and/or processing the claim in an accelerated claim payment group. In an embodiment, the plurality of provider's parameters may include a flag to indicate that a threshold total cost was exceeded, a flag to indicate the claim should be included in the accelerated payment group, and/or a provider identifier to indicate a provider wants an accelerated payment. In an embodiment, the plurality of payer's parameters may include a flag to indicate that a threshold total cost was exceeded, a flag to indicate the claim should be included in the accelerated payment group and/or a payer identifier to indicate that a payer will accept an accelerated payment.

In an embodiment, clinical coding verification may be performed on the claim. In an embodiment, performing eligibility verification may be performed on the claim. In an embodiment, determining a payment amount may include reconciling the claim based on remittance advice. Filtering a claim may include filtering a claim in real time to determine whether the claim is eligible for accelerated claim payment. The claim may be submitted, in real time, to a payer. Determining a payment amount for the claim may include determining a payment amount in real time.

In an alternate embodiment, a system for accelerating a health care claim payment may include a processor and a processor-readable storage medium in communication with the processor. The processor-readable storage medium may contain one or more programming instructions for performing the following when executed: filtering a claim to determine whether the claim is eligible for accelerated claim payment, determining a payment amount for the claim by retaining a provider level adjustment, automatically paying the payment amount and distributing a portion of the provider level adjustment.

In an embodiment, the processor-readable storage medium may be configured to store the claim. The processor-readable storage medium may be configured to store one or more valid or invalid combinations of product and service codes. The processor-readable storage medium may further contain one or more programming instructions for performing eligibility verification on the claim.

In an alternate embodiment, a computer program product may include a computer usable medium having a computer readable program code embodied therein. The computer readable program code may be adapted to be executed to implement a method for accelerating a health care claim payment. A claim may be filtered to determine whether the claim is eligible for accelerated claim payment. A payment amount for the claim may be determined by retaining a provider level adjustment. The payment amount may be automatically paid via electronic funds transfer. A portion of the provider level adjustment may be distributed via electronic funds transfer.

In an embodiment, filtering the claim to determine whether the claim is eligible for accelerated claim payment may include obtaining a plurality of provider's parameters, determining if data from the claim corresponds with the provider's parameters, obtaining a plurality of payer's parameters, determining if data from the claim corresponds with the payer's parameters and/or processing the claim in an accelerated claim payment group. In an embodiment, the plurality of provider's parameters may include a flag to indicate that a threshold total cost was exceeded, a flag to indicate the claim should be included in the accelerated payment group and/or a provider identifier to indicate a provider wants an accelerated payment. In an embodiment, the plurality of payer's parameters may include a flag to indicate that a threshold total cost was exceeded, a flag to indicate the claim should be included in the accelerated payment group and/or a payer identifier to indicate that a payer will accept an accelerated payment. In an embodiment, distributing a portion of the provider level adjustment may include distributing a portion of the provider level adjustment only if a service level is exceeded.

### BRIEF DESCRIPTION OF THE DRAWINGS

Aspects, features, benefits and advantages of the embodiments described herein will be apparent with regard to the following description, appended claims, and accompanying drawings where:

FIG. 1 depicts an exemplary accelerated claim payment system according to an embodiment.

FIG. 2 depicts an exemplary method of accelerated claim payment according to an embodiment.

FIG. 3 discloses a method of filtering according to an embodiment.

FIG. 4 depicts a block diagram of an exemplary system that may be used to contain or implement program instructions according to an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

A “claim” is a record of healthcare products or services provided to an individual patient that is recorded to report the delivery of the products or services. The claim may be recorded by a processor-readable storage medium. In an embodiment, the claim may be recorded electronically in a digital format. Claim data is the information in the claim. In an embodiment, the claim may include a paper document or an electronic document.

“Remittance advice” is information based on a claim that has been re-priced in accordance with the embodiments described below. Remittance advice may include, but is not limited to, the re-priced allowed amount, the re-priced amount of covered services, the re-priced amount of non-covered services, the re-priced amount of payer responsibility, and/or the re-priced amount of patient responsibility.

“Electronic funds transfer” (EFT) is a system of transferring money directly between bank accounts without exchanging paper payment. Funds are transferred electronically using an electronic funds transfer/automated clearinghouse (EFT/ACH).

As used herein, the phrase “real time” may be used when referring to an action that occurs automatically and without artificial delay. A real time event introduces no delay to the processing time. A real time event may include an event that occurs immediately, an event that take a few seconds or an event that take a few minutes to process.

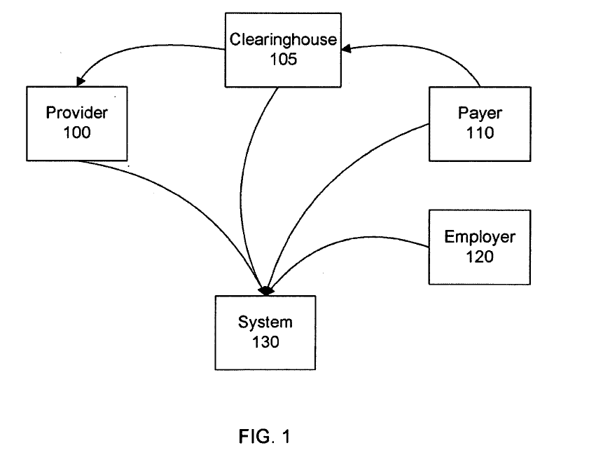

FIG. 1 depicts an exemplary accelerated claim payment system 130 according to an embodiment. An accelerated claim payment system may include a processor and a processor-readable storage medium. An accelerated claim payment system may be accessed by a provider 100. A provider is a health care practitioner or institution that delivers health care to a patient in need of health care services. A provider may be a healthcare practitioner which includes, but is not limited to, a dentist, an optometrist, a psychologist, a physician, or a doctor. A provider may also be a healthcare institution such as, but not limited to, a hospital or a doctor's office.

The accelerated claim payment system may be used by or in communication with a payer 110. A payer processes one or more claims. A payer may include, but is not limited to, a third party administrator (TPA), a health care administrator, a health maintenance organization (HMO), and/or a preferred provider organization (PPO). In an embodiment, the accelerated claim payment system may be used by or in communication with an organization such as a PPO. A PPO is an organization of hospitals, doctors, dentists and/or other health care providers who have contracted with an insurance company or other TPAs to provide medical services at a reduced rate to the insurance company's or the TPA's patients.

A clearinghouse 105 may provide an intermediary between a provider 100 and a payer 110. A clearinghouse collects and distributes information. A clearinghouse may include a processor and a processor-readable storage medium. A clearinghouse in an accelerated claim payment system may collect and distribute claims and/or claim data. A clearinghouse may perform tasks related to claims, such as, but not limited to, claim processing, claim filtering, claim verifying and/or other services necessary for a provider and/or a payer.

In an embodiment, the system may be used by or in communication with an employer 120. An employer is a person or entity that hires an employee. Within an accelerated claim payment system, an employee may be a patient of a provider. An employer 120 may purchase some or all of the insurance that covers some or all of the employee's health care costs. A TPA 110 may pay a portion or the entire payment of an employee's claim to the provider 100.

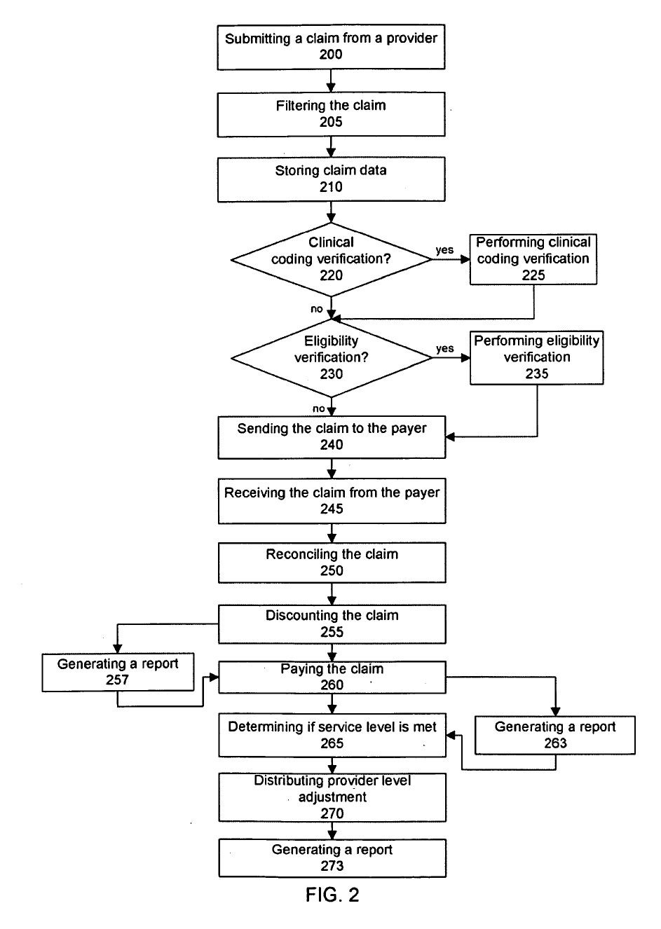

FIG. 2 depicts an exemplary method of accelerated claim payment according to an embodiment. The provider, through a practice management system or hospital information system (PMS/HIS system), may submit a claim 200. The PMS/HIS system may include the billing system that a physician or hospital uses to create a claim.

At a clearinghouse, a claim may be filtered to determine whether the claim is qualified for accelerated payment 205. In an embodiment, filtering may occur in real time. One or more claims may be filtered into an accelerated claim payment group. In an embodiment, there may be an accelerated claim payment group and a standard claim payment group. Additional groups and/or subgroups are possible. In an embodiment, the claims may be placed in more than two groupings. The claims may be examined based on the claim data. Claim data may include, but is not limited to, the charge for a particular procedure, the total charge for all procedures included in the claim, the procedure code and/or a provider identifier.

Claims may be grouped by determining whether a claim conforms to one or more parameters. A parameter is a criterion, condition or standard. Filtering may occur by comparing the parameters with the claim data. Parameters may include, but are not limited to, total charges, procedural codes which may be used to exclude certain claims, provider identifiers and/or flags created by the provider to indicate if a claim should be included or excluded from an accelerated claim payment group.

In an embodiment, a health care provider and/or payer may provide the clearinghouse with a set of parameters by which to filter claims. A provider's parameters may include, but are not limited to, a flag to indicate that a threshold total cost was exceeded, a flag to indicate a claim should be included in the accelerated payment and/or a provider identifier to indicate a provider wants an accelerated payment. A payer's parameters may include, but are not limited to, a flag to indicate that a threshold total cost was exceeded, a flag to indicate a claim should be included in the accelerated payment and/or a payer identifier to indicate that a payer will accept an accelerated payment.

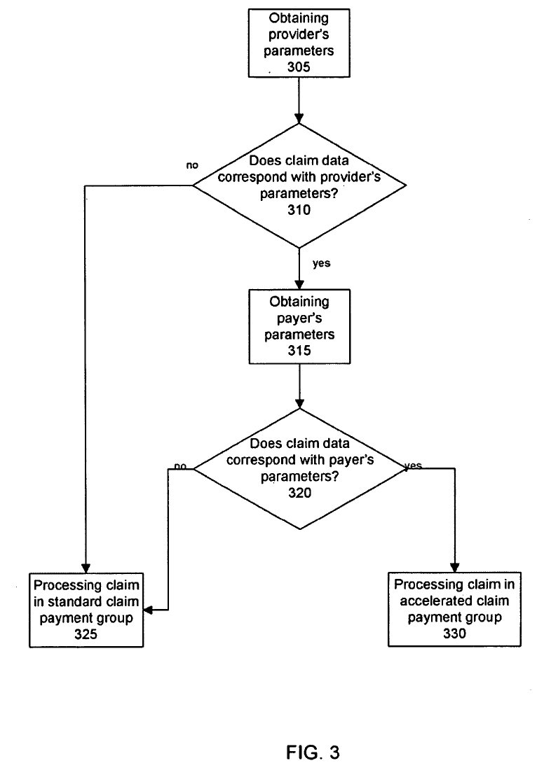

FIG. 3 discloses a method of filtering according to an embodiment. According to FIG. 3, one or more parameters may be obtained from a provider 305. After the one or more parameters are obtained, the provider's parameters may be compared with the claim data 310. By comparing the provider's parameters with the claim data, the system may determine whether the claim may be processed as an accelerated claim payment. There may be one or more parameters and each parameter may be compared with the claim data. If one or more of the provider's parameters do not correspond with the claim data, then the claim may be processed in the standard claim payment group 325. In an embodiment, if claim data does not correspond with each of the one or more parameters, then another set of provider's parameters may be used to filter the claim. For example, a claim may not correspond with one of the provider's parameters. Therefore, a second provider's parameter may be used to further determine whether the claim may be placed in the accelerated claim payment group.

If the claim data corresponds with the provider's parameters, one or more parameters from the payer may be obtained 315. The claim data may be compared with the one or more payer's parameters 320. In an embodiment, the one or more payer's parameters may already be obtained. If the claim data does not correspond with the one or more payer's parameters, then the claim may be processed in the standard claim payment group 325. In an embodiment, if claim data does not correspond with each of the one or more parameters, then another set of payer's parameters may be used to filter the claim. If the claim data corresponds with the payer's criteria, then the claim may be processed in the accelerated claim payment group 330.

Returning to FIG. 2, the clearinghouse may store a record of key fields from the claim data 210. The record may be stored to indicate whether the claim is eligible for accelerated payment. In an embodiment, the record may be stored during filtering. In an embodiment, the record may be stored after filtering.

The one or more claims may optionally be checked using clinical coding verification 220. In an embodiment, clinical coding verification may be performed 225. Clinical coding may be performed to determine whether a claim is correctly coded and/or to determine whether the claim data contains abnormal data. By checking the abnormalities or cleanliness of the claim in such a manner, claims with incorrect coding may be rejected and not sent into the accelerated payment process.

In an embodiment, clinical coding verification may use a configurable rules engine. Clinical coding verification may include, but is not limited to, examining diagnosis codes, examining procedural codes, examining procedure modifiers to analyze medical appropriateness and compliance with correct coding initiatives and/or examining codes for national and local Medicare coverage determinations.

Clinical coding verification may include, but is not limited to, verifying the accuracy or validity of a product or a service code. A product code refers to an identifier indicating a product delivered to a patient. A service code refers to an identifier indicating a service delivered to a patient. In an embodiment, the product or service code may be based on now or hereafter-existing current procedural technology (CPT) from the American Medical Association, the Health Care Financing Administration Common Procedural Coding System (HCPS) Codes, the Home Infusion EDI Coalition (HIEC) Product/Service Code, the National Drug Code in 4-4-2 Format, the National Drug Code in 5-3-2 Format, the National Drug Code in 5-4-1 Format, the National Drug in 5-4-2 Format and/or other defined codes. In an embodiment, clinical coding verification may vary based on the health plan where the claim is submitted, the payer, the provider rendering the products and/or services and/or the facility or location where the service was rendered.

Clinical coding verification may include, but is not limited to, determining whether a product or service code may be missing or invalid by cross-referencing the product or service code against a list of valid codes, determining whether a procedure modifier may be an invalid combination with the included product or service code by cross-referencing valid and/or invalid combinations, determining whether a procedure modifier may be invalid in combination with another procedure modifier by cross-referencing valid and/or invalid combinations and/or determining whether a specific procedure modifier, such as modifier 35/36, may be required by cross-referencing valid and/or invalid combinations. In an embodiment, valid and/or invalid combinations of product and service codes may be stored in a computer readable storage medium.

Clinical coding verification may also include, but is not limited to, determining whether similar services were recorded for one patient on the same date of service, determining whether one or more product or service codes may be bundled into a more appropriate product or service code by cross referencing a list of product and service codes and/or determining whether one or more product or service codes may be unbundled into one or more appropriate product or service codes by cross-referencing a list of product or service codes. In an embodiment, a list of product and service codes that may be bundled or unbundled may be stored in a computer readable storage medium.

Clinical coding verification may further include, but is not limited to, determining whether a patient is a new or established patient, determining whether a patient's age is invalid based on the product and/or service code, determining whether a patient was given anesthesia by a non-anesthesiology provider, determining whether a patient's gender is correct, determining whether the International Classification of Diseases (ICD) code is invalid or missing, determining whether there may be a local carrier determination (LCD) policy, determining whether a diagnostic test occurred in a hospital setting, determining whether a post-operation procedure occurred which was related to the product or service code, determining whether the place of service is missing or invalid, determining whether there is a Medicare unrelated surgery and/or determining whether the Medicare codes may be bundled or unbundled.

Clinical coding verification may be used to determine whether a claim is eligible for accelerated claim payment. In an embodiment, if a claim is incorrectly coded, the claim may be removed from the accelerated claim payment processing and may be placed into the standard claim processing group. In an embodiment, an incorrectly coded claim may not be sent any further into the payment system. In an embodiment, the incorrectly coded claim may be sent back to the provider. In an embodiment, only the claims placed in the accelerated claim processing group may have clinical coding verification performed. In an alternate embodiment, all claims may have clinical coding verification performed.

Returning to FIG. 2, the claim optionally may be examined using eligibility verification 230. In an embodiment, eligibility verification may be performed 235. Eligibility verification is also a form of claim scrubbing. By checking eligibility verification, a claim for an ineligible patient may be rejected and not sent into the process. Eligibility verification may include a variety of criteria regarding the claim such as, but not limited to, ensuring the patient has active coverage as of the dates of service, determining whether a procedure was performed, and/or determining whether a coverage guideline was met. An example of eligibility verification may include determining whether the patient or subscriber identification is valid. Additionally, eligibility verification may include determining whether the patient or subscriber identifier was valid during a specific period of time.

For example, data for a claim may indicate that a patient had knee surgery on Jul. 6, 2007. The provider may charge $10,000 for the knee surgery. The claim may be filtered using both the provider's parameters and the payer's parameters. The provider's parameters and the payer's parameters may both accept knee surgeries which cost under $20,000. The claim may meet the provider's and payer's parameters. Therefore, the claim may be further examined to determine whether the claim may be filtered into the accelerated claim payment group.

However, upon clinical coding verification, the clearinghouse may determine that the coding for the knee surgery was incorrect. The claim data may be coded for knee surgery, but the patient may have been diagnosed with a slipped disk in the patient's back. Therefore, as a result of the error found during the clinical coding verification, the claim may be removed from the accelerated claim payment group.

In an alternate embodiment, the clinical coding verification may have found that the claim was coded correctly and the claim may remain in the accelerated claim payment group. However, upon eligibility verification, the claim may be scrubbed and other criteria may be examined. The eligibility verification system may find that the patient was not covered for knee surgery on Jul. 6, 2007. Therefore, the claim may be removed from the accelerated claim payment group.

During filtering, clinical coding verification and/or eligibility verification, the claims may be sorted to determine which claims are eligible for accelerated payment. However, all the claims, whether or not they are eligible for accelerated payment, may be sent to the payer 240. In an embodiment, the payment may be sent to the payer in real time.

The payer may process and adjudicate the one or more claims. The payer may verify the patient's eligibility, determine patient benefits, and re-price the claim. The claim may be re-priced based on a provider contract. A provider contract is an agreement between the payer and a health care provider which includes a contracted rate for one or more services. A claim may be submitted for a certain amount and the claim may be re-priced based on pre-negotiated rates for one or more provider services. For example, a claim for a service may be $1,000. However, the pre-negotiated rate may state that the payer will only pay 80% of the $1,000 for that service. Therefore, the claim may be re-priced for $800.

In an embodiment, a payer may be a PPO. Various providers may join a PPO network to create a group providing a variety of health care services. The PPO may re-price a claim based on the contracts with the providers in the PPO network.

After the one or more claims are processed by the payer, the one or more adjudicated claims may be received by the clearinghouse 245. The adjudicated claim is the payment amount given to the provider for the claim. In an embodiment, the adjudicated claim may be received by the clearinghouse in real time. Therefore, when the one or more adjudicated claims are received as electronic data interchange (EDI) with remittance advice, the clearinghouse may reconcile which adjudicated claims are eligible for accelerated payment processing 250.

Reconciliation 250 may begin when the clearinghouse receives the EDI with remittance advice of the one or more adjudicated claims. The adjudicated claim with remittance advice may be matched with key fields from the claim data in the saved records to determine whether the claim was previously deemed eligible for accelerated payment.

In an embodiment, the clearinghouse may also determine whether a time period between claim submission to the payer and receipt of remittance advice was met. Remittance advice may include matching the adjudicated claim with one or more key fields. Key fields may include, but are not limited to, the date of service, the start date of service, the end date of service, the claim number, the patient account number, and/or the subscriber identifier. Other fields may also be used in remittance. The other fields may be optional fields or key fields. The other fields may include, but are not limited to, the patient's first name, the patient's last name, a procedure code, a service code and/or submitted charges such as claim level total and/or for each service line.

Reconciliation 250 may require key fields from the claim record to match the adjudicated claim. Optional fields may be used to create a confidence rating based on a scoring mechanism. In an embodiment, if a match is positive, the confidence rating may be greater than a threshold.

After the claim is reconciled 250 and thus determined eligible for accelerated payment, the clearinghouse may discount the claim 255. In an embodiment, the amount of the discount may be displayed on a computing device. In an embodiment, a report may be generated 257 which includes the amount of the discount for each claim and/or for a set of claims. A report may be printed, faxed, scanned or otherwise displayed. The clearinghouse may apply a discount to the payer's portion (or payer's responsibility) of the claim to create a discounted payer payment. A discounted payer payment is a monetary amount retained or not paid by a clearinghouse for providing a provider with an accelerated payment. The clearinghouse may debit the payer the original payer responsibility amount and may credit the provider with the discounted payer payment. The clearinghouse may modify the electronic data interchange (EDI) with remittance advice to reflect the discount. In an embodiment, the modified EDI with remittance advice may be displayed on a computing device at the location of a clearinghouse and/or payer. In an embodiment, a report may be generated which includes the modified EDI with remittance advice. Part of the discounted payer payment may be retained by the clearinghouse for its services.

In an embodiment, the amount in the financial information (BPR) segment may be modified to reflect the sum of the discounted payer payments contained in a payment loop. A provider adjustment (PLB) segment may be added to reflect the total adjustment of all claims in an EDI payment loop. Adding the provider adjustment may ensure that the EDI remains balanced. In an embodiment, claim supplemental information (ATW) segment may be added to reflect the discount for each adjusted claim. In an embodiment, some or all of the financial information may be displayed on a computing device at the location of a clearinghouse and/or a payer. In an embodiment, a report may be generated which includes financial information.

The claims may be paid 260. In an embodiment, the claims may be automatically paid via electronic funds transfer (EFT). In an embodiment, if a claim is eligible for accelerated claim payment, the clearinghouse may process the claim and may take and distribute money. Money may be distributed to bank accounts of employers and/or providers and discounts may be given. In an embodiment, employers and/or providers may be notified of the monetary distribution via electronic mail and/or a report generated 263 on a daily, weekly, biweekly, monthly or other periodic time or intermittent time basis.

In an embodiment, the money collected by the clearinghouse may be based on the money the provider obtains. The provider may charge a certain amount, such as $130, for a procedure, such as blood work. The third party administrator may only pay the provider $108 for this service. The claim may be processed and paid through the clearinghouse using the accelerated claim payment system. The clearinghouse may send the provider $88. When the provider receives the check for $88, the payment information from the clearinghouse may indicate that the original payment amount was $130, but the third party administrator will only pay $108 for the procedure. The payment information may also indicate that the payment of $88 is because the clearinghouse discounted the payment due to the accelerated claim payment system. The $20 ($108 minus $88) may be the amount retained by the clearinghouse.

In an embodiment, an electronic remittance advice (ERA) may be created and funding may occur via an electronic transfer fund/automated clearinghouse (EFT/ACH). An EFT/ACH may debit funds from a payer and may credit funds to a provider. The EFT/ACH may use a payment network. A payment network facilitates the debiting and crediting of funds. A qualifying discount adjustment may be calculated. A rebate may be returned to the employer or the payer and funds may be maintained for the clearing house's services. In an embodiment, an employer and/or payer may be notified of the monetary distribution via a printed report.

In an embodiment, the clearinghouse or a third party may pay the provider via EFT. The clearinghouse or third party may pay a provider on a daily, weekly, monthly or other periodic time or intermittent time basis. In an embodiment, the clearinghouse or third party may fund the provider before the claim is adjudicated. The payer may pay (or reimburse) the clearinghouse or the third party once the claim is adjudicated. If the payment is not the full amount that the clearinghouse or third party paid the provider, the clearinghouse or third party may withhold the amount as an adjustment on future payments. The payer may pay the provider via EFT once a final adjudication has been made. If the provider was paid twice, the clearinghouse or third party may debit the provider the second amount paid. Alternatively, the payer may pay the clearinghouse or third party directly via EFT and not pay the provider a second time.

For example, a claim may be eligible for an accelerated claim payment. The remittance may take a couple days as the claim may be sent to the accelerated claim payment system and then sent back to the clearinghouse for reconciliation. In the meantime, the clearinghouse or a third party may pay the provider via EFT. The provider may be notified of the payment via electronic notification and/or a printed report. Then, the payer, who has not received notice that the provider has already been paid, may pay the provider as well. Therefore, when the provider is paid for a second time, the clearinghouse or the third party, who fronted the money for the provider, may debit the money, via EFT, from the provider so that the provider is only paid once and the clearinghouse or the third party is repaid.

In an example of an accelerated claim payment, the provider may submit ten claims. The submitted charges may be $1,200. The payer may re-price and recalculate an allowed amount of $1,100. Upon applying benefits, the payer may be responsible for $1,000 and the patients may be responsible for $100. The payer may create an electronic remittance advice (ERA) and may authorize funding via EFT/ACH. The clearinghouse or a third party may receive the electronic data interchange (EDI) which contains the remittance information. Upon receiving the EDI, the clearinghouse or third party may discount the one or more claims which are qualified for accelerated payment. The clearinghouse or third party may enter a provider level adjustment of negative $50 against the $1,000 to be paid by the payer. The $50 may be the accelerated payment discount/provider level adjustment. Therefore, the total payment paid by the clearinghouse or third party may be $950, even though the claims may total $1,000.

The clearinghouse or third party may debit $1,000 from the payer/employer's bank account via EFT. This amount equals the payer/employer's payment according to the EDI with remittance information. Therefore, the amount debited from the payer/employer's bank account will be the amount from the EDI with remittance information sent from the payer/employer to the clearinghouse/third party. The clearinghouse/third party may credit $950 to the provider's bank account. The clearinghouse or third party may credit the payment to a provider on a daily, weekly, monthly or other periodic time or intermittent time basis.

From the provider level adjustment, the clearinghouse/third party may distribute accrued accounts, discounts and/or rebates to the payer/employer, while reserving fees for its service 270. In an embodiment, a report may be generated 273 which includes the one or more portions distributed from the provider level adjustment.

In an embodiment, the payer/employer may receive a portion of the provider level adjustment if the payer/employer adjudicates claims within a service level 265. In an embodiment, the service level may be a time period between claim submission to the payer/employer and receipt of remittance advice to the clearinghouse/third party. The time period may be a pre-negotiated time period between the payer/employer and the clearinghouse/third party. These fees are the accelerated payment discount fees. For example, of the $50 retained as the provider level adjustment, $40 may go to the payer/employer with $10 retained by clearinghouse/third party as a charge for its service. In an embodiment, the payer/employer may receive $40 only if the payer/employer adjudicates the claims within a service level.

The accelerated payment discount may be applied only after the remittance information to ensure that the system balances. If the accelerated payment discount is applied after a claim is repriced for standard contract by the PPO, the accelerated payment discount may affect both the patient portion and the payer portion. This would be problematic as payment from the patient portion is not accelerated. An accelerated payment discount may not be applied until the claim is adjudicated. Since the EDI with remittance information may be received by the clearinghouse after all the claim adjudication is complete, there may be no impact on the amount of the provider level adjustment.

For example, if a claim having a total submitted charge of $300 may be re-priced at $250, $250 may be the total allowed amount. The payer may need to apply the patient benefits. The patient may not have met the required deductible, so the patient may be responsible for $250. Therefore, the payment amount may not be changed because no payment is being accelerated. Only the amount being paid by the payer may be deducted and not the amount provided by the patient.

Therefore, after remittance information is provided, the clearinghouse may calculate the accelerated payment discount. The accelerated payment discount may be used in the EDI in two places. First, there may be a provider level adjustment, which may be at the end of the file. For example, if a patient's claims total $1,000, one may enter an adjustment of $50 at the end for the accelerated payment discount. The provider level adjustment may be part of the balance of the EDI so the total payment may be $950, due to the accelerated payment discount, even though the claims still total $1,000. On each claim, there may be an additional information segment which may denote the adjustment amount per claim. The additional information segment may not be part of the balancing.

For example, $1,000 may be debited from the employer as stated on the EDI. This may ensure that everything balances. The EDI with remittance advice of the adjudicated claim may be added to the accelerated payment discount to credit $950 to the provider. On a daily, weekly, monthly or other periodic or intermittent basis, the accrued discounts may be distributed, which may send $40 to the employer and keep $10 for the clearinghouse. Therefore, the employer or third party may receive the accelerated discount money at a later time.

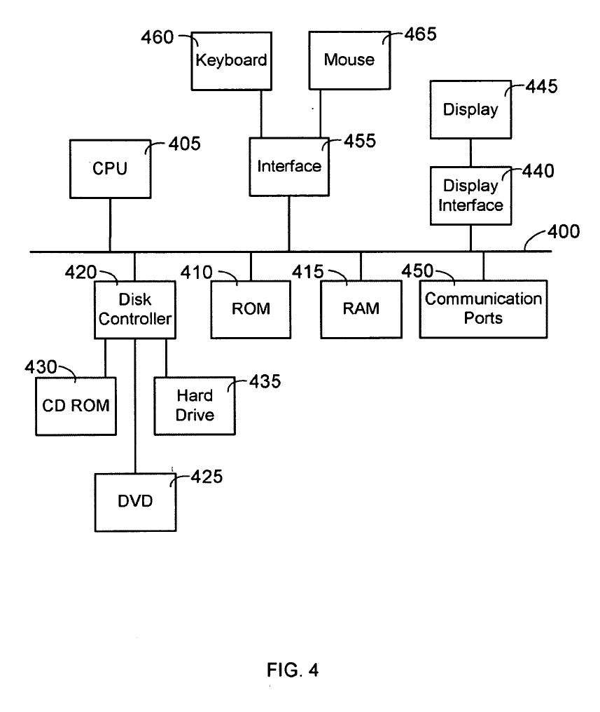

FIG. 4 depicts a block diagram of an exemplary system that may be used to contain or implement program instructions according to an embodiment. Referring to FIG. 4, a bus 400 serves as the main information highway interconnecting the other illustrated components of the hardware. A processor (designed as CPU 405) is the central processing unit of the system, performing calculations and logic operations required to execute a program. Read only memory (ROM) 410 and random access memory (RAM) 415 constitute exemplary memory devices or storage media.

A disk controller 420 interfaces with one or more optional disk drives to the system bus 400. These disk drives may include, for example, external or internal DVD drives 425, CD ROM drives 430 or hard drives 435. As indicated previously, these various disk drives and disk controllers are optional devices.

Program instructions may be stored in the ROM 410 and/or the RAM 415. Optionally, program instructions may be stored on a processor-readable storage medium, such as a hard drive, a compact disk, a digital disk, a memory or any other tangible recording medium.

An optional display interface 440 may permit information from the bus 400 to be displayed on the display 445 in audio, graphic or alphanumeric format. Communication with external devices may occur using various communication ports 450.

In addition to the standard computer-type components, the hardware may also include an interface 455 which allows for receipt of data from input devices such as a keyboard 460 or other input device 465 such as a mouse, remote control, touch pad or screen, pointer and/or joystick.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of accelerating a health care claim payment comprising:
filtering a claim to determine whether the claim is eligible for accelerated claim payment;
determining, via a computing device, a payment amount for the claim by retaining a provider level adjustment;
automatically paying the payment amount via electronic funds transfer; and
distributing, via electronic funds transfer, a portion of the provider level adjustment.

2. The method of claim 1 wherein distributing a portion of the provider level adjustment comprises distributing a portion of the provider level adjustment only if a service level is exceeded.

3. The method of claim 1 wherein filtering the claim to determine whether the claim is eligible for accelerated claim payment comprises:
obtaining a plurality of provider's parameters;
determining if data from the claim corresponds with the provider's parameters;
obtaining a plurality of payer's parameters;
determining if data from the claim corresponds with the payer's parameters;
processing the claim in an accelerated claim payment group.

4. The method of claim 3 wherein the plurality of provider's parameters comprise one or more of the following:
a flag to indicate that a threshold total cost was exceeded,
a flag to indicate the claim should be included in the accelerated payment group, and
a provider identifier to indicate a provider wants an accelerated payment.

5. The method of claim 3 wherein the plurality of payer's parameters comprise one or more of the following:
a flag to indicate that a threshold total cost was exceeded,
a flag to indicate the claim should be included in the accelerated payment group, and
a payer identifier to indicate that a payer will accept an accelerated payment.

6. The method of claim 1 further comprising:
performing clinical coding verification on the claim.

7. The method of claim 1 further comprising:
performing eligibility verification on the claim.

8. The method of claim 1 wherein determining a payment amount comprises:
reconciling the claim based on remittance advice.

9. The method of claim 1 wherein filtering a claim comprises filtering a claim in real time to determine whether the claim is eligible for accelerated claim payment.

10. The method of claim 1, further comprising:
submitting the claim, in real time, to a payer.

11. The method of claim 1 wherein determining a payment amount for the claim comprises determining a payment amount in real time.

12. A system for accelerating a health care claim payment, the system comprising:
a processor; and
a processor-readable storage medium in communication with the processor;
wherein the processor-readable storage medium contains one or more programming instructions for performing the following when executed:
filtering a claim to determine whether the claim is eligible for accelerated claim payment,
determining a payment amount for the claim by retaining a provider level adjustment,
automatically paying the payment amount, and
distributing a portion of the provider level adjustment.

13. The system of claim 12 wherein the processor-readable storage medium is configured to store the claim.

14. The system of claim 12 wherein the processor-readable storage medium is configured to store one or more valid or invalid combinations of product and service codes.

15. The system of claim 12 wherein the processor-readable storage medium further contains one or more programming instructions for performing eligibility verification on the claim.

16. A computer program product, comprising a computer usable medium having a computer readable program code embodied therein, the computer readable program code adapted to be executed to implement a method for accelerating a health care claim payment, the method comprising:
filtering a claim to determine whether the claim is eligible for accelerated claim payment;
determining a payment amount for the claim by retaining a provider level adjustment;
automatically paying the payment amount via electronic funds transfer; and
distributing, via electronic funds transfer, a portion of the provider level adjustment.

17. The computer program product of claim 16 wherein filtering the claim to determine whether the claim is eligible for accelerated claim payment comprises:
obtaining a plurality of provider's parameters;
determining if data from the claim corresponds with the provider's parameters;
obtaining a plurality of payer's parameters;
determining if data from the claim corresponds with the payer's parameters;
processing the claim in an accelerated claim payment group.

18. The computer program product of claim 17 wherein the plurality of provider's parameters comprise one or more of the following:
a flag to indicate that a threshold total cost was exceeded,
a flag to indicate the claim should be included in the accelerated payment group, and
a provider identifier to indicate a provider wants an accelerated payment.

19. The computer program product of claim 17 wherein the plurality of payer's parameters comprise one or more of the following:
a flag to indicate that a threshold total cost was exceeded,
a flag to indicate the claim should be included in the accelerated payment group, and
a payer identifier to indicate that a payer will accept an accelerated payment.

20. The computer program product of claim 16 wherein distributing a portion of the provider level adjustment comprises distributing a portion of the provider level adjustment only if a service level is exceeded.
